(19) United States
(12) Patent Application Publication
(10) Pub. No.: US 2024/0373241 A1
(43) Pub. Date: Nov. 7, 2024

(54) APPARATUS AND METHOD FOR POWER-EFFICIENT CELLULAR OPERATION BASED ON DUAL PURPOSE HARDWARE AND NETWORK CONTROLLERS

(71) Applicant: NTT DOCOMO, INC., Tokyo (JP)

(72) Inventors: Haralabos Papadopoulos, Sunnyvale, CA (US); Fujio Watanabe, Sunnyvale, CA (US); Yoshiaki Oofuji, Tokyo (JP)

(21) Appl. No.: 18/650,845

(22) Filed: Apr. 30, 2024

Related U.S. Application Data
(60) Provisional application No. 63/463,749, filed on May 3, 2023.

(51) Int. Cl. H04W 16/14; H04B 7/155; H04W 52/02; H04W 88/10

(52) U.S. Cl. CPC H04W 16/14; H04B 7/155; H04W 52/0206; H04W 88/10

(57) ABSTRACT

Apparatuses and methods for cellular operation are disclosed. In some embodiments, a communication network includes: a plurality of cells, where each cell of the plurality of cells has a base station and a local network controller, and at least one of the cells has both hardware for performing cellular communication operations and repeater hardware to enable the at least one cell to operate as a repeater during a first reduced power consumption state. The communication network also includes a master network controller coupled to the local network controllers in each of the plurality of cells, where the master network controller is configured to select the at least one cell to enter the first reduced power consumption state and signal the local network controller of the at least one cell to enable the repeater hardware to have the at least one cell operate as a repeater.

### RELATED APPLICATION

The present application is a non-provisional application of and claims the benefit of U.S. Provisional Patent Application No. 63/463,749, filed May 3, 2023, and entitled “APPARATUS AND METHOD FOR POWER-EFFICIENT CELLULAR OPERATION BASED ON DUAL PURPOSE HARDWARE AND NETWORK CONTROLLERS”, which is incorporated by reference in its entirety.

### FIELD OF THE DISCLOSURE

Embodiments of the present disclosure are related to wireless communication; more particularly, embodiments disclosed herein related to cellular communication where at least one of the cells has both hardware for performing cellular communication operations and repeater hardware to enable operating as a repeater during a reduced power consumption state.

### BACKGROUND

Today, mobile network operators consider power consumption and carbon dioxide consumption because the energy used to power mobile networks contributes to greenhouse gas emissions and climate change. In addition to the environmental impact, excessive power consumption can also result in increased operational costs for network operators. Therefore, by considering and reducing their power consumption and carbon dioxide emissions, mobile network operators can help mitigate the negative impact of their operations on the environment, while also improving their bottom line.

One of the options people are considering for reducing power usage is turning base-stations off during low traffic periods. However, if a mobile network operator puts a cell to sleep, they can create a coverage hole, which would make many of their customers unhappy.

One solution to handle the coverage hole is to have nearby cells tilt their antennas up in order to increase their coverage in an attempt to close the coverage hole. There are a number of issues that exist with this approach. First, even after titling, the coverage hole may still exist. Second, titling the antennas of nearby cells can cause more interference in other nearby cells (which are not put to sleep). Furthermore, handovers between the cells can also be affected such that there may be an increased number of failed handovers due to re-tilting. All of these problems can become even more aspirated if a mobile network operator wants to put several cells to sleep at the same time to save significant power.

### SUMMARY

Apparatuses and methods for cellular operation are disclosed. In some embodiments, a communication network includes: a plurality of cells, where each cell of the plurality of cells has a base station and a local network controller, and at least one of the cells has both hardware for performing cellular communication operations and repeater hardware to enable the at least one cell to operate as a repeater during a first reduced power consumption state. The communication network also includes a master network controller coupled to the local network controllers in each of the plurality of cells, where the master network controller is configured to select the at least one cell to enter the first reduced power consumption state and signal the local network controller of the at least one cell to enable the repeater hardware to have the at least one cell operate as a repeater.

In some other embodiments, a cell includes a local controller and hardware for performing cellular communication operations and repeater hardware to enable the at least one cell to operate as a repeater during a first reduced power consumption state.

In yet some other embodiments, a method includes transmitting, by each cell of a plurality of cells in a communication network, using hardware for performing cellular communication operations; selecting, by a master network controller coupled to the local network controllers in each of the plurality of cells, at least one cell to enter a reduced power consumption state; signaling, by the master network controller, the local network controller of the at least one cell to enable repeater hardware to have the at least one cell operate as a repeater; and at least one cell operating as a repeater using repeater hardware during the reduced power consumption state.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates some embodiments of a communication network.

FIG. 2 illustrates the case of a dual hardware station connecting to a donor cell.

FIG. 3 illustrates an arrangement in which a dual hardware station is able to enter a reduced power consumption state.

FIG. 4 illustrates expanded cover areas of neighbor base station when a dual hardware station has entered or is in the sleep mode.

FIG. 5 illustrates some embodiments of a dual hardware station of a site.

FIG. 6 illustrates some embodiments of the master controller performing

operations to place cells in a reduced power consumption state while maintaining or addressing coverage issues with respect to such cells.

FIG. 7A illustrates some embodiments of the dual hardware at a site.

FIG. 7B illustrates normal operation when a local controller at site A toggles switches to enable a full-stack cell processor to be coupled to an antenna used for cellular communication.

FIG. 7C illustrates a dual hardware station at site A during low-power operation.

FIG. 7D illustrates an example of operating a dual hardware cell that includes a wired connection to a donor cell antenna.

FIG. 8 illustrates an example of local controller-based gradual switching in the repeater function.

FIG. 9 illustrates another example of some embodiments of a controller-based gradual switching at a site.

FIG. 10 illustrates some embodiments of a group of cells during normal operation.

FIG. 11 illustrates some embodiments of a group of cells during normal operation.

FIG. 12 illustrates an example of some embodiments of a master/local controller-based gradual switching at a site.

FIG. 13 illustrates some embodiments of gradual switching between normal and low power (repeater) operation.

FIG. 14A is a data flow diagram of some embodiments a process for transition operation of a communication network into the low power consumption mode.

FIG. 14B is a flow diagram of some embodiments of process for transitioning from the normal mode to the sleep mode.

FIG. 15 illustrates as multi-band example of some embodiments of controller-based gradual switching from normal operation to sleep operation.

FIG. 16 illustrates another multi-band example of some other embodiments of controller-based gradual switching from normal operation to sleep operation.

### DETAILED DESCRIPTION

In the following description, numerous details are set forth to provide a more thorough explanation of the present disclosure. It will be apparent, however, to one skilled in the art, that the present disclosure may be practiced without these specific details. In other instances, well-known structures and devices are shown in block diagram form, rather than in detail, to avoid obscuring the present disclosure.

Embodiments described herein enable a mobile network operator to put one or more cells into a reduced power consumption state during certain periods of time in order to have a more power-efficient network. In some embodiments, these time periods are during low traffic periods. In order to reduce the impact on a user's experience, embodiments described herein help mobile network operators to have a next-generation power-efficient network.

In some embodiments, to facilitate reduced power operation, the network includes two network controllers to provide a seamless transition to a terminal (e.g., mobile phone, user device, etc.) while a base station goes into a power-saving mode. The first of the two controllers is referred to herein as the main controller. The main controller monitors the entire network traffic situation and controls the power management of each base station. In some embodiments, the main controller also controls the channel assignment. The second controller, referred to herein as the local controller, manages the power-saving mode at a dual hardware base station that includes functionality to perform the base station operations and functionality to perform repeater operations.

Embodiments herein initiate a handoff from the associated base station to other base stations with handoff management being implemented, or otherwise performed, by channel allocation and power management. Note that this is in contrast to a conventional dual-mode base station having two different network systems such as Wi-Fi and cellular where terminals can have dual connectivity to maintain a connection.

During the power-saving mode, the main controller causes a reduction in the transmission power and/or shuts down the Tx/Rx (transmission power and receiving power) at a base station. When the associated base station goes into the power-saving mode, in order to prevent the terminal from losing a connection to the associated base station, thereby causing significant service disruption, the main controller and the local controller manage which operating channel (e.g., frequency) will be shut down and when the operating channel's power is reduced. In other words, while the associated base station transitions into sleeping mode, the associated terminal is automatically initiated to handoff to other base stations using the channel (e.g., frequency) management. In some embodiments, the sleeping mode means that the associated base station will shut down its power or reduce power.

Thus, the two network controllers are harmonized to keep current associated connections as well as maximize power efficiency. In this manner, embodiments disclosed herein provide a seamless transition of communication functionality before an associated base station transitions into sleep mode, while providing efficient power management within a managed area.

### Dual Hardware Base Stations

In some embodiments, the network includes additional hardware at a site. The site can be a base station. In some embodiments, the hardware can work as a regular cell but also as a repeater. For example, in normal operation, the hardware works as a standard cell, while in low-traffic scenarios, it works as a standard repeater. In some embodiments, the repeater is designed so as to have the same coverage as the standard cell, and can have a substantially lower energy footprint. For example, the repeater comprises a SureCall's repeater @ 28 GHz provide the same coverage as a full-fledged cell using only 30 W. In some embodiments, the hardware is also equipped with a special purpose controller to enable gradual and seamless transition between normal and low-traffic operation.

The use of the additional hardware includes a number of benefits with respect to baseline sleep operation. Embodiments include one or more of the following benefits. First, use of the additional hardware avoids coverage holes being created when a switch to low-power operation occurs, which in turn keeps customers happy. Second, no re-tilting of nearby cells is required, and therefore no additional interference is created. Third, it is much easier to put to large numbers of cells, which translates into much more significant power savings. Fourth, it's easier to study impact of low power operation, as the interference levels stay fixed. For example, it's easy to predict when low-power operation would be needed and when a cell should get out of it and its easy to predict impact on handovers and cell planning.

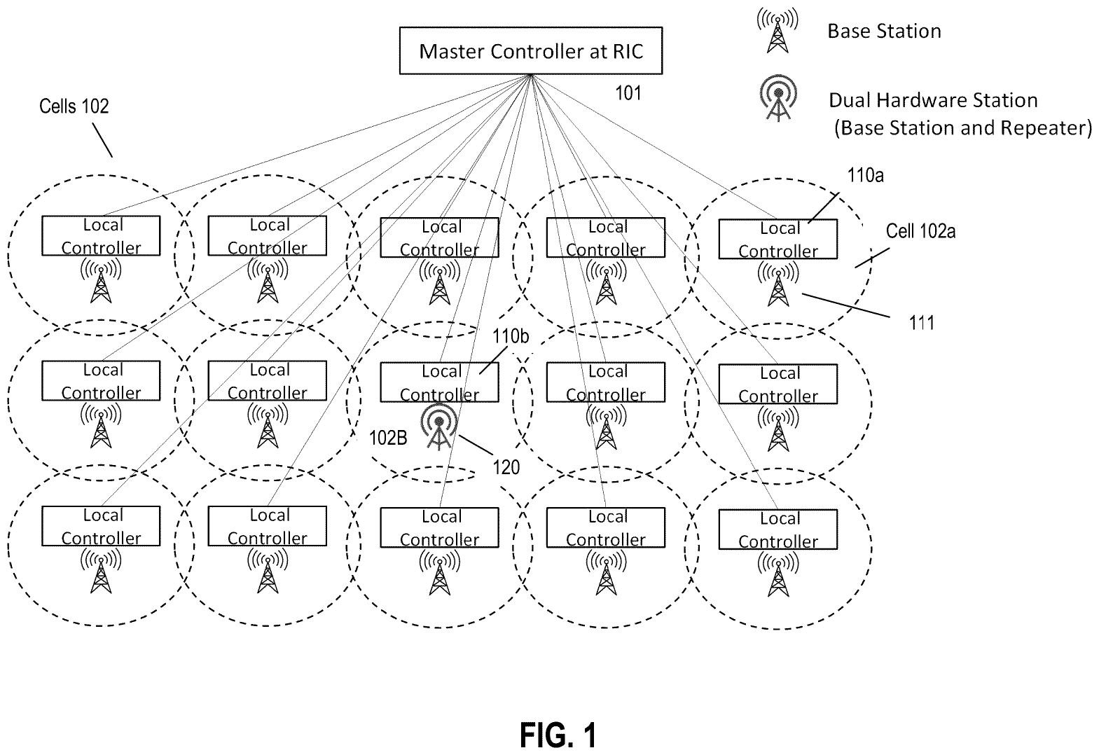

FIG. 1 illustrates some embodiments of a communication network. Referring to FIG. 1, the communication network comprises a master controller 101 and a plurality of cells 102. In some embodiments, master controller 101 is located in a RAN intelligence controller (RIC). Each of the cells 102 includes a local controller and a base station. For example, cell 102a comprises local controller 110a and base station 111. Master controller 101 is communicably coupled to each of the local controllers in cells 102. One or more of the cells 102 comprises a dual hardware station. For example, cell 102B comprises dual hardware station 120 along with local controller 110b. In some embodiments, the dual hardware station comprises of base station and a repeater. In some embodiments, a majority or every cell includes a dual hardware station.

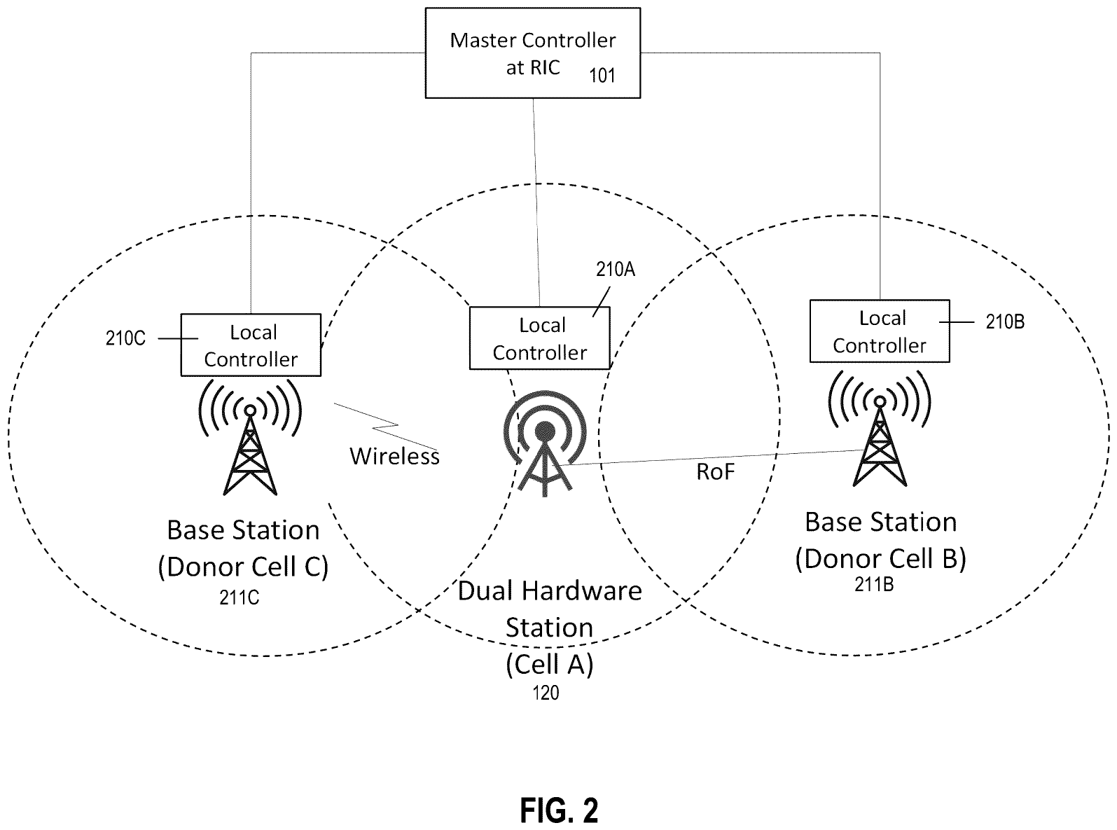

In some embodiments, the dual hardware station in a cell can be communicably connected directly to another base station referred to herein as a donor cell by a wired connection. The wired connection can be a fiber connection (e.g., radio on fiber (RoF)). FIG. 2 illustrates the case of a dual hardware station connecting to a donor cell. Referring to FIG. 2, dual hardware station 120 is in cell A along with local controller 210A. Donor cells B and C are located nearby cell A and its dual hardware station 120. Donor cell B includes base station 211B and local controller 210B, while donor cell C comprises base station 211C and local controller 210C. Base station 211B of donor cell B is communicably coupled to dual hardware station 120 via RoF (or some other wired connection). When dual hardware station 120 operates as a repeater, a signal from donor cell B can be directly carried over the RoF. In this case, cell A will amplify the signal and transmit it.

In some embodiments, the signal from donor cell C can be received at cell A using a wireless link as a usual wireless repeater. In such a case, dual hardware station 120 of cell A amplifies the signal and transmits it onward.

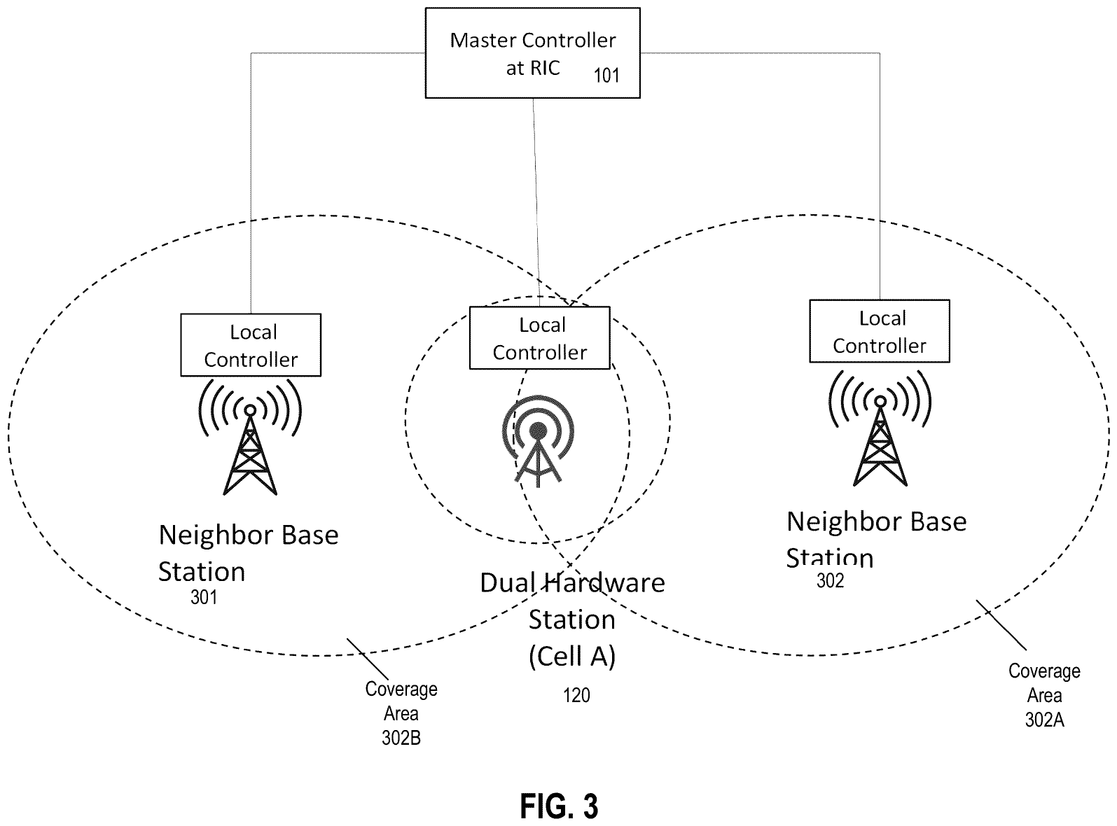

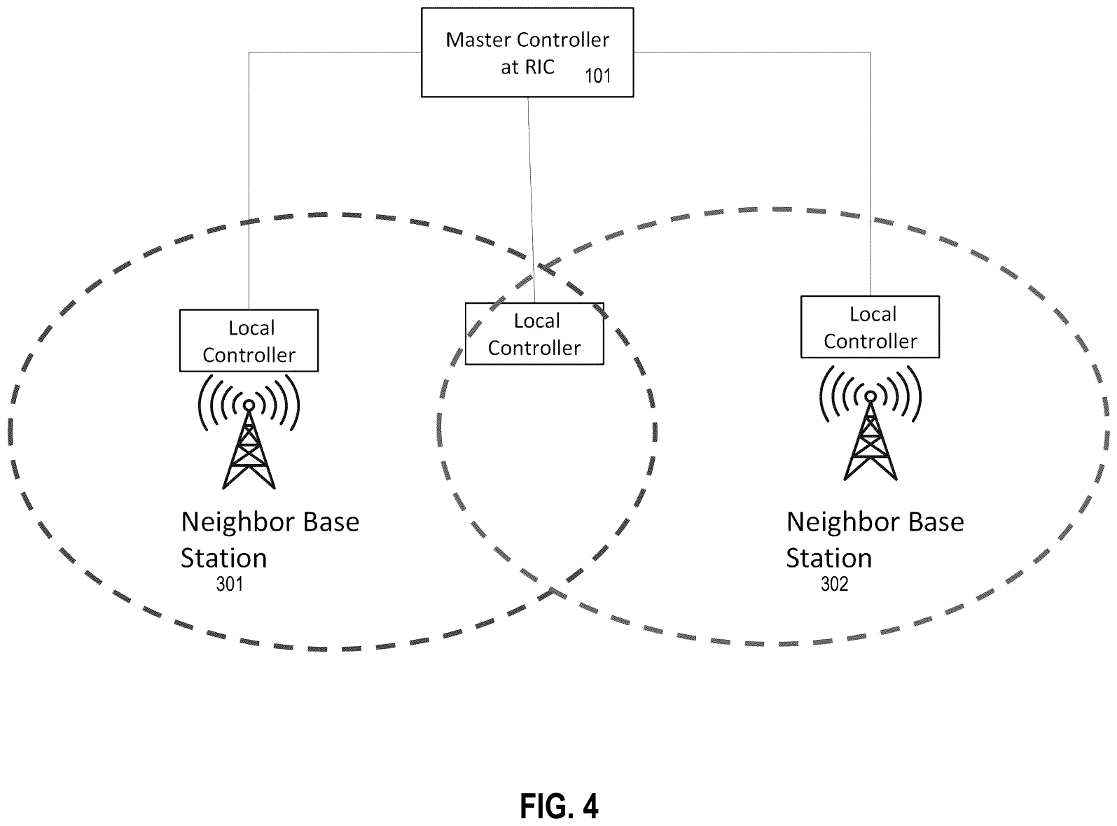

In some embodiments, the power of dual hardware station 120 can be reduced so that dual hardware station 120 enters a reduced power consumption state. In some embodiments, the reduction of power is gradual. In some embodiments, after the power of dual hardware station 120 is gradually reduced, it will eventually shut down. FIG. 3 illustrates such an arrangement. When the dual hardware station is shut down, one or more neighboring cells change the tilt angle of their antenna to provide coverage for the cell A area. FIG. 4 illustrates the expanded cover areas of neighbor base station 301 and 302 when the dual hardware station has entered or is in the sleep mode. As dual hardware station 120 enters a reduced power consumption state, the coverage areas of the neighboring base stations 301 and 302 are expanded by changing the tilt angle of their antennas such that their coverage area is expanded to cover at least a portion of cell A's coverage area. For example, neighbor base station 301 has it's tilt angle changed so that coverage 302B expands to cover a portion of cell A's coverage area, while the neighbor station 302 has the tilt angle of its antenna changed to expand coverage area 302A to cover at least a portion of the coverage area of cell A. In some embodiments, one or more of these antennas increase their tilt by a small amount, e.g., by an amount in the order of 0.5 degrees to 2 degrees (as the repeater hardware can be concurrently used to cover other portions of the coverage areas for a cell). In some embodiments, some of the antennas may need to be tilted up by as many as 5 degrees or more. In some embodiments, these large tilts could happen gradually, and could be accompanied by gradual reduction of TX power (and thus coverage area) at cell A. Note that mechanisms for tilting of antennas is well-known in the art. Therefore, when dual hardware station 120 finally enters the sleep mode, and the base station functionality and repeater functionality is in a reduced power consumption state, the neighboring stations 301 and 302 provide coverage of cell A through their changed tilt angle.

In some embodiments, the repeater has the same transmit (TX)/receive (RX) power as the base station. However, in some embodiments, the repeater does not have the same TX/RX power as the base station. In some embodiments, the repeaters transmit at millimeter wave frequencies.

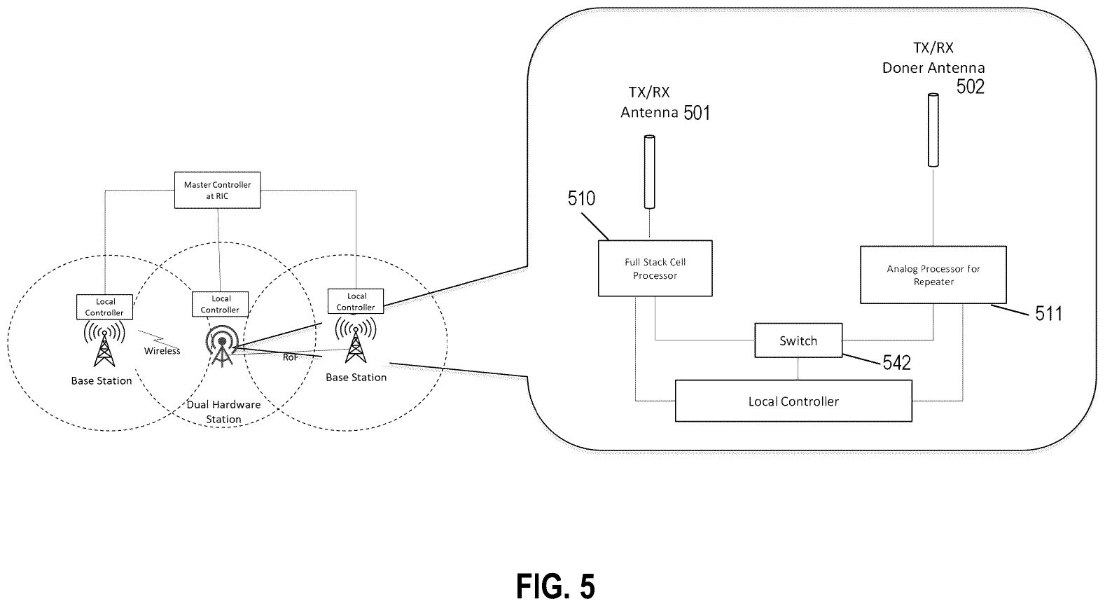

FIG. 5 illustrates some embodiments of a dual hardware station of a site. Referring to FIG. 5, dual hardware station 120 includes switch 542 coupled to the local controller 210A of dual hardware station 120. The hardware includes a full stack cell processor 510 for performing cellular communication operations for the site. In some embodiments, the full stack cell processor 510 is configured with the entire (e.g., 3GPP-defined) protocol stack to perform cellular communication. Full stack cell processor 510 is coupled to switch 542 and local controller 210A. In some embodiments, switch 542 is part of local controller 210A. Dual hardware station 120 also includes an analog processor 511 for a repeater. Analog processor 511 is coupled to switch 542, local controller 210A and TX/RX donor antenna 502.

Switch 542 allows local controller 210A to switch between driving the TX/RX antenna (or RU) 502 with a signal coming from full stack cell processor 510 and the signal coming from analog processor 511. When dual hardware station 120 is using cellular communication, local controller 210A switch 542 to enable full stack cell processor 510 to utilize TX/RX antenna 501 to perform cellular communication. At other times, when dual hardware station 120 is operating as a repeater, local controller 210A controls switch 542 to couple to enable communication by the repeater under the control of analog processor 511 through TX/RX donor antenna 502. Thus, local controller 210A uses switch 542 to control when the cell communicates with TX/RX antenna 501 or TX/RX donor antenna 502.

In some embodiments, the base station and repeater functionality, along with antennas, are logically co-located with each other. However, in some embodiments, the repeater functionality is co-located with the base station. In some other embodiments, the repeater functionality is not co-located with the base station. The antennas 501 and 502 can be located remotely from the base station and repeater functionality (e.g., processors). In some embodiments, one or both of antennas 501 and 502 are remote radio heads (RRHs).

Note that, while FIG. 5 shows one repeater, a dual hardware station can comprise multiple repeaters. Furthermore, each repeater can have its own associated donor and/or TX/RX antenna.

When the master controller (e.g., master controller 101) desires to place one or more cells in a reduced power consumption state, the master controller communicates with the local controller of the cells to determine whether one or more of the cells can be placed into a reduced power consumption state and selects those cells to be powered down while selecting other cells to operate with the tilt change to provide coverage for one or more cells that are being placed in the reduced power consumption state.

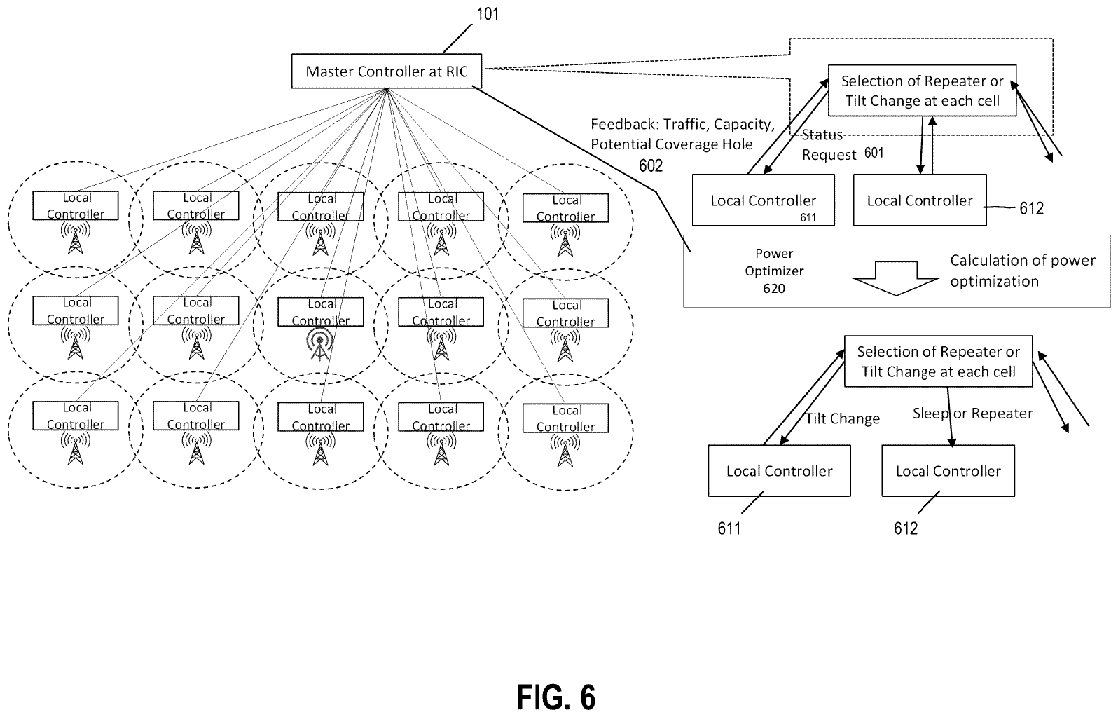

FIG. 6 illustrates some embodiments of the master controller performing operations to place cells in a reduced power consumption state while maintaining or addressing coverage issues with respect to such cells. Referring to FIG. 6, master controller 101 sends status request 601 to local controllers in the cells, such as local controllers 611 and 612. In response to the status request, local controllers, such as local controllers 611 and 612, send feedback response messages to the master controller 101. In some embodiments, these feedback response messages include information related to one or more of network traffic, cell capacity, and potential coverage holes that may exist if the cell is powered down, etc. Using this feedback information, the master controller 101 performs a calculation of the power optimization 620 and uses this information to select cells for power down. In some embodiments, the power optimization is performed by running an algorithm at the master controller. In some embodiments, the algorithm takes into account the network traffic requirements shared by the local controllers and turns them into network capacity requirements across the coverage area. Subsequently, the algorithm tries to find the minimum power footprint that can match or exceed these requirements. In some embodiments, the algorithm greedily switches cells into a lower power state, one at a time (provided in each case the capacity requirements can be met by the new configuration), until no more power savings are possible without compromising QoE. In some embodiments, a reverse mechanism is applied to turn one or more cells into higher power consumption stage, in order to account for increased network traffic (and guarantee QoE can still be met with increased network traffic).

In some embodiment, the selection includes selecting which cells are to be commanded to perform a tilt change to their antenna, which cells are going to enter the sleep station, or which are going to operate as repeaters. This information is communicated to the local controllers. For example, master controller 101 sends control signals to local controller 611 to have the base station undergo a tilt change to its antenna to expand coverage beyond the current coverage of the cell, while signaling local controller 612 to put its hardware in a sleep state or operate as a repeater for communications.

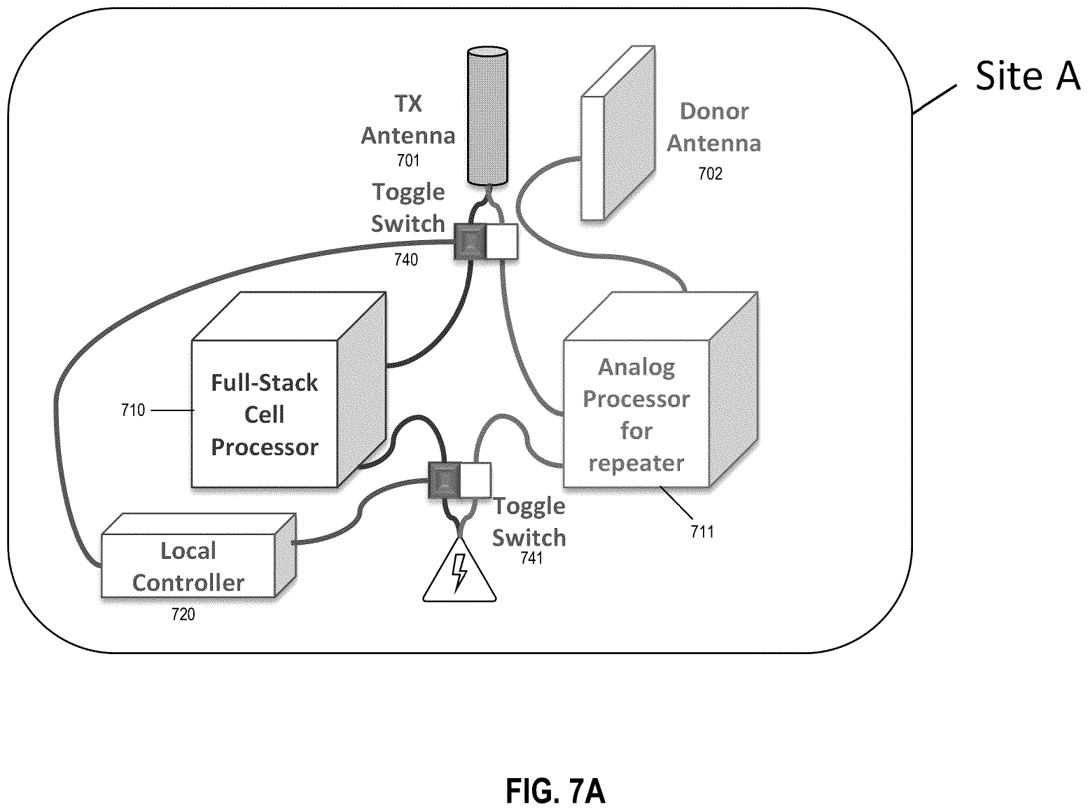

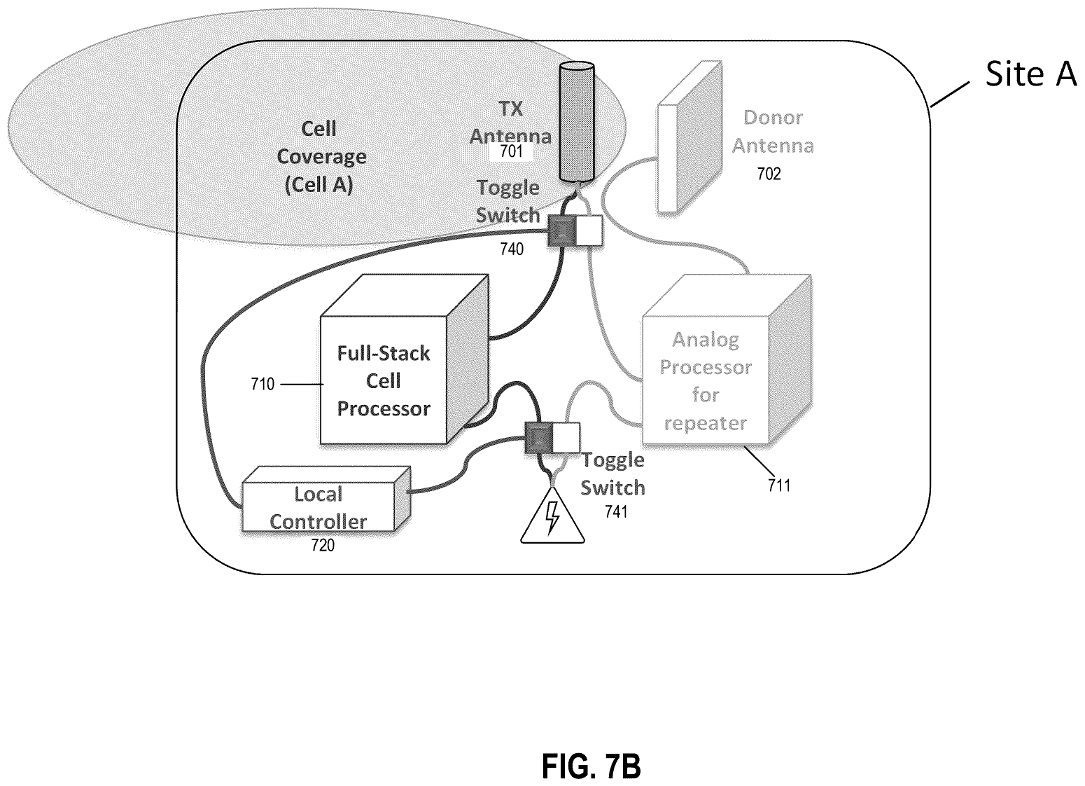

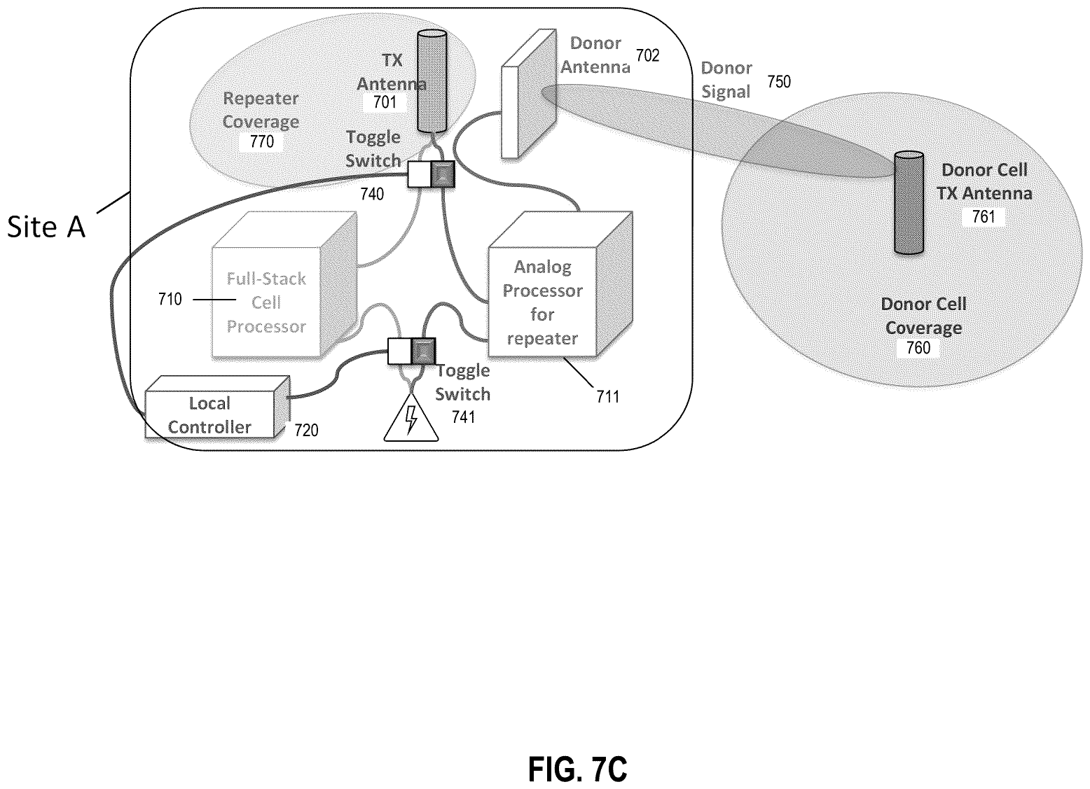

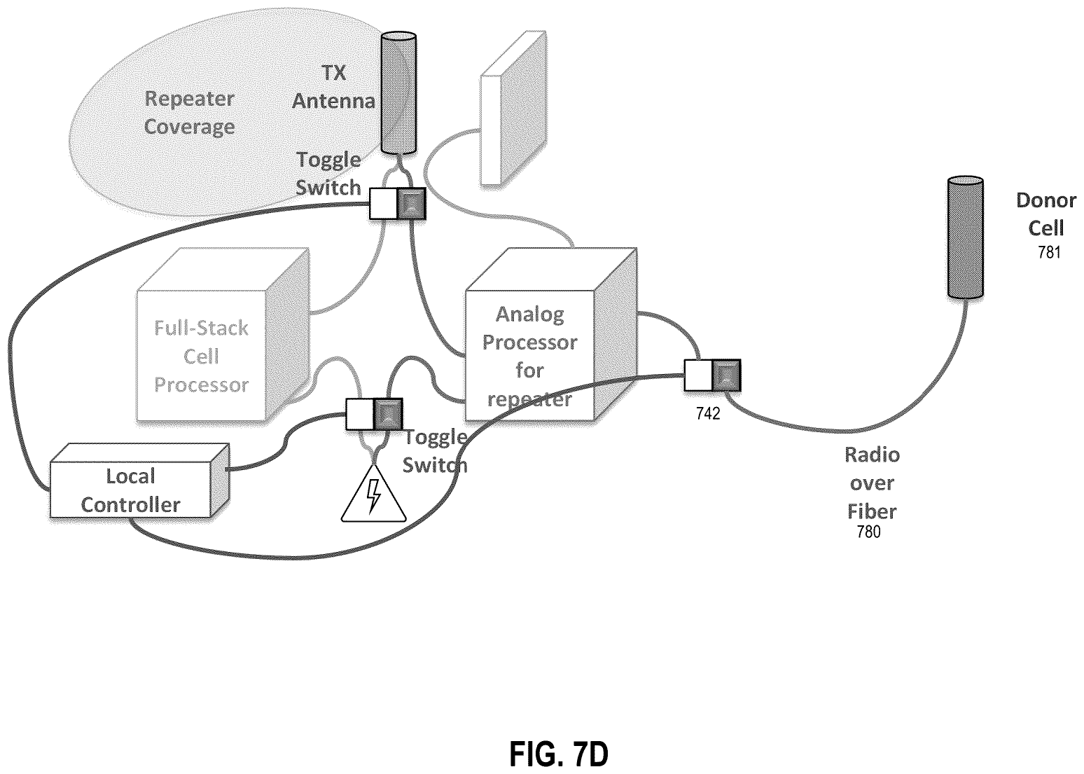

Referring back to FIG. 5, in some embodiments, cells with a dual hardware station are able to use the hardware for regular cellular communication or also as a repeater. By toggling a toggle switch 542 in one way, the full-stack cell processor 510 of the dual hardware station is enabled to perform cellular communication, and by toggling switch 542 the other way, the repeater with the analog processor 511 is able to be used as a repeater. FIG. 7A illustrates some embodiments of the dual hardware at a site. Referring to FIG. 7A, site A includes hardware that operates as either a regular cell but is also operable as a repeater. Two toggle switches 740 and 741 toggle between having the full-stack cell processor 710 and the analog processor 711 coupled to the antenna 701. In some embodiments, toggle switches 740 and 741 are controlled by local controller 720. As shown in FIG. 7A, local controller 720 has set toggle switches 740 and 741 to connect full-stack cell processor 710 to antenna 701, while disconnecting analog processor 711 from antenna 701. When operating as a regular cell, local controller 720 toggles switches 740 and 741 so that full-stack cell processor 710 uses antenna 701 for both transmit and receive operations. When operating as a repeater, local controller 720 toggles switches 740 and 741 so that, in the downlink, analog processor 711 uses antenna 701 for transmit operations and donor antenna 702 for receive operations. That is, for downlink transmission, donor antenna 702 receives the signal from another entity and antenna 701 re-transmits it over its coverage area. In the uplink direction, antenna 701 receives signals transmitted by UEs over its coverage area, and donor antenna 702 re-transmits them to the other site for further processing (through a full stack processor).

FIG. 7B illustrates normal operation when local controller 720 at site A toggles the toggle switches 740 and 741 to enable full-stack cell processor 710 to be coupled to antenna 701. FIG. 7C illustrates the dual hardware station at site A during low-power operation. Referring to FIG. 7C, local controller 720 controls toggle switches 740 and 741 to enable analog processor 711, thereby connecting analog processor to antenna 701. During low-power operation, analog processor 711 communicates with a donor cell via donor antenna 702 and provides repeater coverage with antenna 702. For example, a donor signal 750 is transmitted between donor antenna 702 and donor cell antenna 761, which operates to provide donor cell coverage area 760. The donor signal 750 can be transmitted from donor cell antenna 761 to donor antenna 702 of site A, and then analog processor 711 can cause the information transmitted via antenna 702 operating as a repeater through the repeater coverage area 770. In some embodiments, a line of sight (LOS) path exists between the donor antenna 702 and the donor cell antenna 761. This can occur if the frequency being used for transmission is millimeter wave. In some embodiments, the repeater signal is within the OFDMs circular prefix.

Using the hardware control at the site as shown in FIG. 7A, in some embodiments, the communication system can put as many cells as desired to sleep as long as the capacity demands and delay constraints (for wireless/wired repeater operation) are met.

In some other embodiments, the dual hardware station includes an additional switch coupling the analog processor for the repeater to a donor cell antenna. In this case, the connection between the analog processor and the donor cell antenna is a wired connection. FIG. 7D illustrates an example of operating a dual hardware cell that includes a wired connection to a donor cell antenna. Referring to FIG. 7D, in the same manner as the hardware in FIG. 7C, controller 720 toggles switches 740 and 741 to enable the repeater function. However, controller 720 also toggles an additional toggle switch 742 coupling analog processor 711 to donor cell 781 via a fiber connection 780 (or other type of wired connection) to enable communication between donor cell 781 and analog processor 711. In some embodiments, the fiber connection is a radio over fiber (RoF) connection. The donor cell 781 shares its signal with the analog processor 711 via the fiber connection 780.

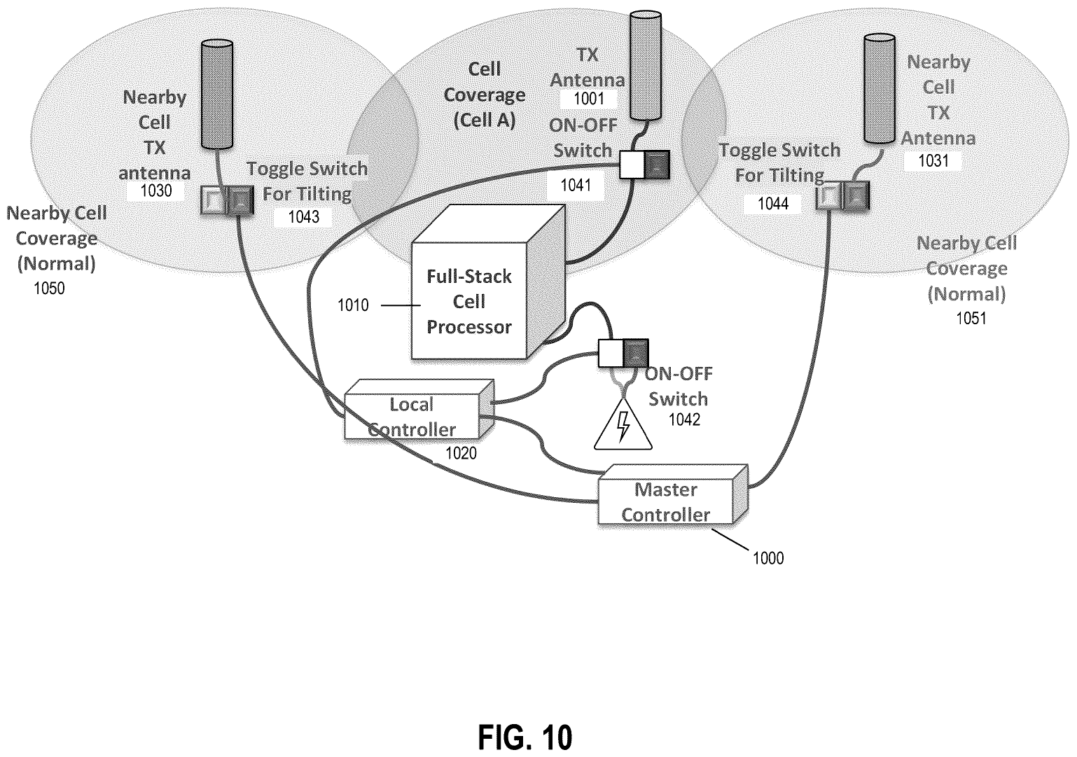

In some embodiments, the donor cell is implemented with or as part of a distributed unit (DU), or donor DU, of an Open Random Access Network (O-RAN), and transmit antenna 701 (and other such transmit antennas, such transmit antenna 501 of FIG. 5 and transmit antenna 1001 of FIG. 10) is implemented with or as part of a radio unit (RU), or recipient RU, of an Open Random Access Network (O-RAN). In some other embodiments, the donor cell is implemented with or as part of a donor processor, and transmit antenna 701 (and other such transmit antennas, such transmit antenna 501 of FIG. 5 and transmit antenna 1001 of FIG. 10) is implemented with or as part of a recipient radio transmission unit.

In some embodiments, the repeater signal transmission is synchronized with the donor cell transmission. This is helpful to deal with multipath. More specifically, if transmitting the same signal from multiple locations and the timing is synchronized, then reception of the transmitted signals can be within the OFDM cyclic prefix (e.g., timing synchronization of the transmitted signals from the two locations ensures that the multipath spread is minimized and is less than the OFDM cyclic prefix duration).

In some embodiments, the full-stack processor powers down before powering up the repeater. In some cases, this can result in service interruptions. In some other embodiments, steps are taken when powering down to avoid causing service interruptions. For example, in some embodiments, the local controller of a site gradually switches between normal operation and low power operation. When performing gradual switching, in some embodiments, both the analog repeater and the full-stack processor are on at the same time. In some embodiments, during the gradual switching, the state of active users in a cell are transferred to the donor cell. during the gradual switching. In some embodiments, the donor antenna wireless link can be replaced with wired connection (e.g., a RoF connection, etc.) to the donor antenna.

In some embodiments, a controller controls the frequency used by donor base stations. For example, in some deployments, many of these TX/RX antennas (e.g., RUs) simultaneously transmit signals at two different frequency bands (that are allocated to a service provider) and these frequency bands are disjoint but nearby each other in carrier frequency. In such a case, the UEs can be served over any one of these bands (or even both at the same time). The fact that a TX/RX (e.g., RU) provides coverage over two different bands enables the performance of a handover during switching from one mode (e.g., full cell stack being used by a cell) to another mode (e.g., when the cell is operating as a repeater) using existing means. In some embodiments, in the “transition” period, there would be what are known as inter-frequency handovers: handing a UE over from one cell in one frequency band to another cell (or possibly the same cell) in another frequency band. In some other embodiments, “soft” switching (i.e., without UEs being dropped in the process) can be enabled by intra-frequency handovers. In this case, the controller splits the radio resources in a single band between the repeater and the full stack signal. This can be accomplished in a number of ways. One way is to split the tones in the OFDM plane into two different chunks and transmit on one chunk a signal generated by the full stack processor and on the other a signal generated by the repeater. In some embodiments, some of the OFDM tones in the middle (between the two chunks) are left unused as a “guardband” to ensure interference between the two signals would be acceptable.

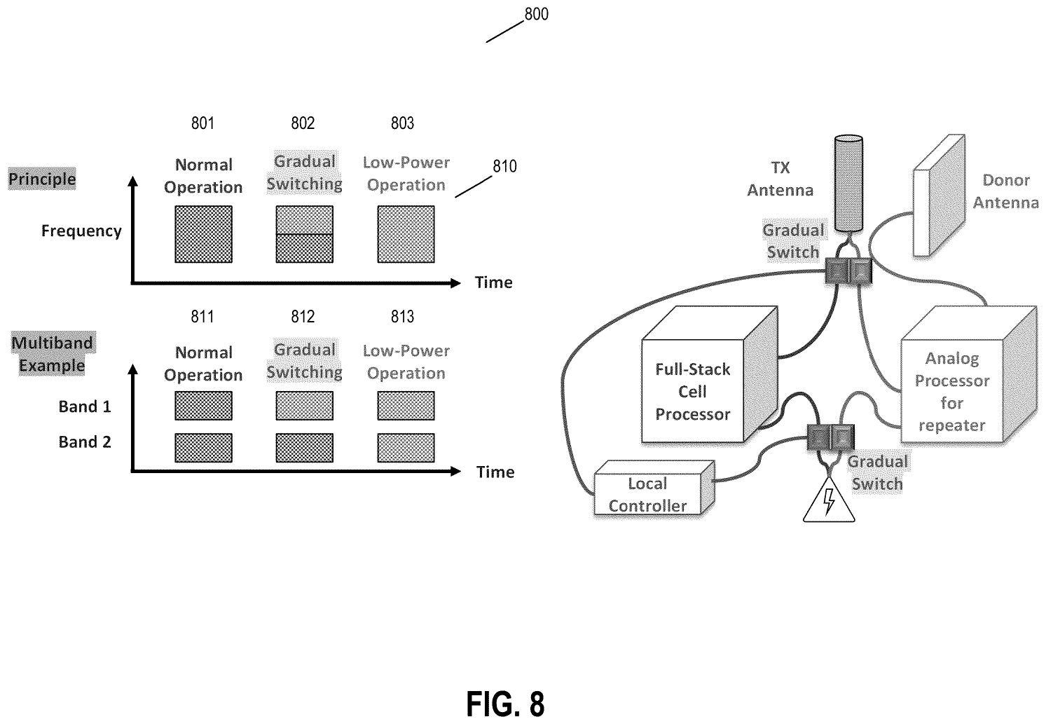

FIG. 8 illustrates an example of local controller-based gradual switching in the repeater function. During the transition, each of the analog processor for the repeater and the full-stack processor is allocated part of the available spectrum for transmission. For example, in FIG. 8, graph 800 shows all of the available spectrum 801 allocated to the full-stack cell processor for normal operation (e.g., cellular operation), a split of the spectrum 802 between the full-stack cell processor for normal cellular operation and the analog processor for repeater operation during the gradual switching, and then the entire available spectrum 803 allocated to the analog processor for the repeater during low-power operation. Note that the split of the spectrum 802 need not be 50/50 between the full-stack cell processor and the analog repeater during gradual switching.

In some embodiments, if a “powered-down” cell transmits over multiple bands, several options for splitting spectrum for gradual switching. For example, in the one example shown in FIG. 8, graph 810 shows all bands of the available spectrum 811 allocated to the full- stack cell processor for normal operation (e.g., cellular operation), a split of the bands for the spectrum 812 between the full-stack cell processor and the analog processor during the gradual switching (e.g., one band being allocated to the full-stack cell processor and one band being allocated to the analog processor during gradual switching, one or more bands being allocated to the full-stack cell processor and one or more bands being allocated to the analog processor during gradual switching etc.), and then all the bands representing the entire available spectrum 813 allocated to the analog processor for the repeater during low-power operation.

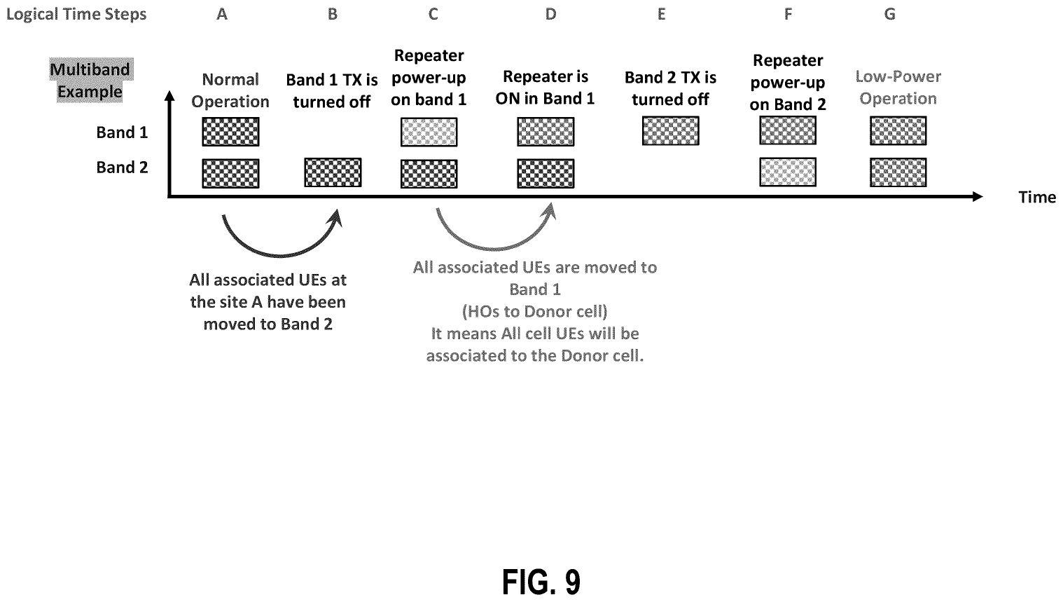

FIG. 9 illustrates another example of some embodiments of a controller-based gradual switching at a site. Referring to FIG. 9, the graph shows the allocation of a spectrum consisting of bands 1 and 2 over a number of logical time steps A-G. At time A, the site hardware is performing its normal cellular operation and both bands 1 and 2 are allocated to the full-stack cell processor. Also during this time, all of the associated UEs at site A are moved to one of the bands, e.g., band 2 in this example. In some embodiments, the local controller enables the transfer of UE state. Note that in some embodiments, this operation is similar to normal handovers (HOs) except the physical identifier (ID) of the cell need not change.

At time B, after the transfer of the UE state of band 1 to band 2, band 1 TX is turned off. At time C, the repeater is powered up on band 1, while band 2 is allocated to the full-stack cell processor. Also during this time, all associated UEs are moved to band 1 and handovers are made to the donor cell, which means that all cell UEs are associated with the donor cell. Again, in some embodiments, the controller enables the transfer of UE state (in a similar way to normal HOs). In some embodiments, the handovers are forced on the UEs, as opposed to UEs requesting the handovers, and the UEs are provided information that specifies the cell to which the UEs should join. In some other embodiments, the UEs are signaled by the base station to perform a handover and thereafter request the handover.

At time D, the repeater is on in band 1 and band 2 is still allocated to the full-stack cell processor. At time E, band 2 TX is turned off, while band 1 remains allocated to the repeater. At time F, while band 1 remains allocated to the repeater, the repeater is powered up on band 2. At time G, both band 1 and band 2 are allocated to the repeater. In some other embodiments, band 2 remains turned off after time E and is not allocated to the repeater, and thus, the gradual switching procedure terminates after time E.

Note that in some embodiments the gradual switching mechanism can also occur over a single band in which the spectrum is split between the full-stack cell processor and the repeater. The local controller can initiate this spectrum split.

In some embodiments, the master controller is used in the standard sleep operation. In this case, the master controller enables gradual switching of a cell to sleep mode while reducing and/or preventing service disruptions. In some embodiments, during normal operation, the cell of interest is on and services its coverage area, while during sleep operation, nearby cells operate as donor cells to provide coverage. In some embodiments, during normal operation, these donor cells having their transmit (TX) antennas tilted for normal operation to cover their coverage area.

FIG. 10 illustrates some embodiments of a group of cells during normal operation. Referring to FIG. 10, master controller 1000 is communicably coupled to local controller 1020 of cell A. Cell A also includes full-stack cell processor 1010, on-off (e.g., toggle) switches 1041 and 1042, which are coupled to and controlled by local controller 1020, and TX antenna 1001. Master controller 1000 is also coupled to and controls toggle switches 1043 and 1044, which are coupled to nearby cell TX antenna 1030 and 1031, respectively. During normal operation, master controller 1000 controls toggle switches 1043 and 1044 so that they are off. In such a case, nearby cell TX antenna 1030 and 1031 are not tilted and provide coverage only for their nearby cell coverage areas 1050 and 1051, respectively.

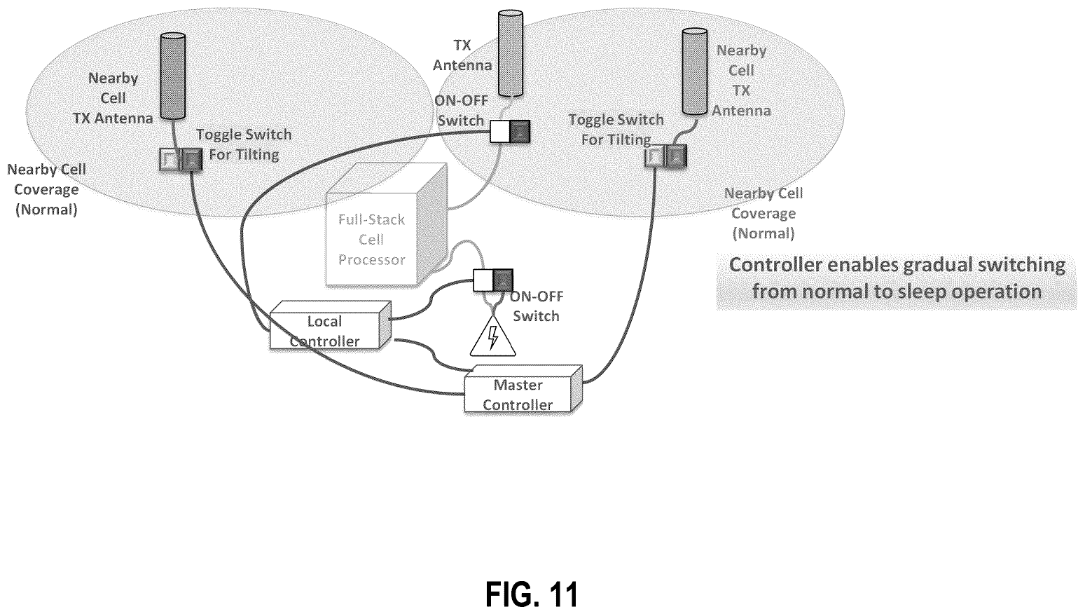

FIG. 11 illustrates some embodiments of a group of cells during normal operation. Referring to FIG. 11, master controller 1000 enables gradual switching from normal to sleep operation. In the case of sleep operation, the cell of interest, such as cell A, is put to sleep by local controller 1020 placing on-off switches 1041 and 1042 in the off position in response to control signals from master controller 1000. Also, master controller 1000 controls switches 1042 and 1043 to enable the nearby cells to operate as coverage donors. In this case, the nearby cells have their TX antennas tilted up to expand their coverage areas 1050 and 1051 to provide coverage to the cell of interest, cell A.

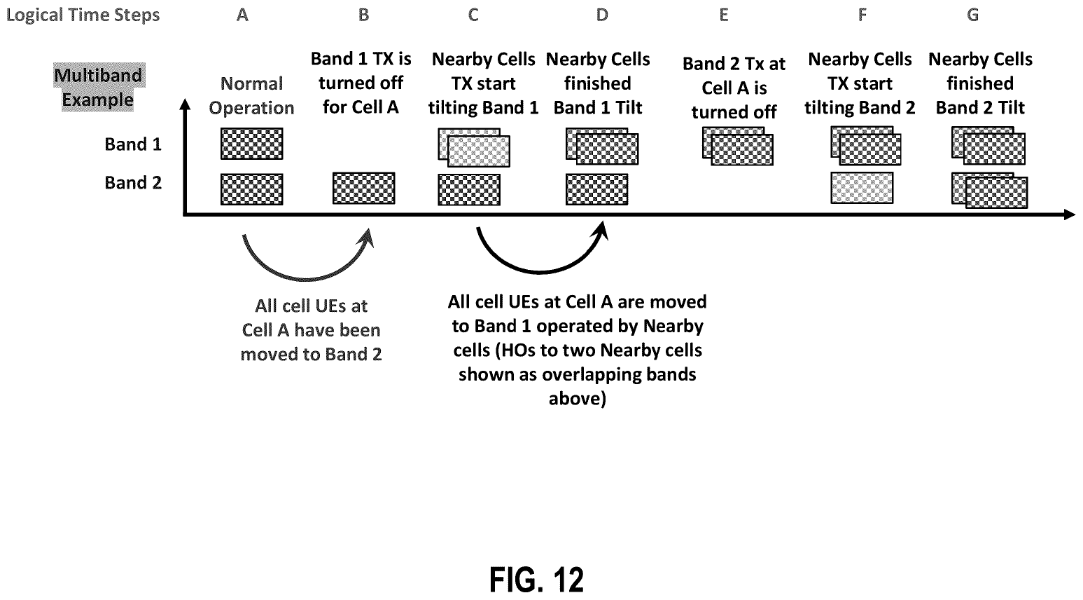

FIG. 12 illustrates an example of some embodiments of a master/local controller-based gradual switching at a site. Referring to FIG. 12, the graph shows the allocation of a spectrum consisting of bands 1 and 2 over a number of logical time steps A-G. At time A, the site hardware is performing its normal operation and both bands 1 and 2 are allocated to the full-stack cell processor of cell A. Also during this time, all of the associated UEs at cell A are moved to one of the bands, e.g. band 2. In some embodiments, the controllers (the local controller and the master controller) enable the transfer of UE state (in a manner like normal HOs). For example, in some embodiments, local controller 1020 manages the band operation ON-OFF and tilt angle change at the cell site, while master controller 1000 manages the entire network optimization for band operation ON-OFF and which cell site should change their tilt angles.

At time B, after the UE state for all UEs has been moved to band 2, band 1 TX is turned off. At time C, the nearby cells TX start tilting band 1 to expand their coverage to cover cell A's area, while band 2 is allocated to the full-stack cell processor. Also during this time, all associated UEs at cell A are moved to band 1 operated by nearby cells (e.g., cells with antenna 1030 and 1031) and handovers are made to the nearby cells. Again, in some embodiments, the master controller enables the transfer of UE state to the nearby cells (in a manner similar to normal HOs). In some embodiments, a UE's Reference Signal Received Power (RSRP) to the two nearby cells on band 1 is used to choose the UE's handover destination.

At time D, the nearby cells finished their band 1 tilt, while band 2 is still allocated to the full-stack cell processor of cell A. In some embodiments, the controller can also request the cell being powered down, i.e., the “sleep” cell, to lower its control signal power (during times C and D). In some embodiments, a weaker received RSRP from the sleep cell (cell A) allows UEs served by the sleep cell to request handover to the nearby cells (the one with the strongest RSRP).

At time E, band 2 TX is turned off, while band 1 remains allocated to the repeater. In some embodiments, the repeater on band 2 may not be turned on, and the gradual switching procedure terminates after time E. At time F, while band 1 remains allocated to the repeater, the repeater is powered up on band 2. Note that in some embodiments, the operations performed during time E and Fare merged into one step. At time G, both band 1 and band 2 are allocated to the repeater.

In some embodiments, a single cell can have many potential donors in the repeater function operation. Some (or all) of the donors can be wired (radio over fiber) donors. Some (or all) of the donors can be wireless donors. In some embodiments, each donor may donate one or more frequency bands. In some embodiments, when each donates these one or more frequency bands, those bands are dedicated for use only with the dual hardware station that is being shut down. In some embodiments, one or more bands is allocated for the dual hardware station.

In some embodiments, a single cell can simultaneously be a donor to many cells with the advanced hardware. In some embodiments, for some cells, this single cell is a wired donor, while for other cells, this single cell is a wireless donor.

In some embodiments, one controller is used per cell and controls the cell/repeater operation on that cell. In some embodiments, the controller switches partially to low power operation. In some embodiments, the low-power operation is enabled on one or more bands, but not necessarily on all bands upon which the cell is transmitting. With respect to the remaining bands (i.e., bands not transitioned to low-power operation), in some embodiments, the cell continues transmitting under normal operation on one or more these bands. This is not very attractive because of the high-power usage. In some other embodiments, regarding remaining bands (i.e., bands not transitioned to low-power operation), the cell is put to sleep on one or more these bands. This would be useful if there's sufficient coverage and capacity provided by one or more of the remaining active bands (e.g., bands in low-power or normal operation).

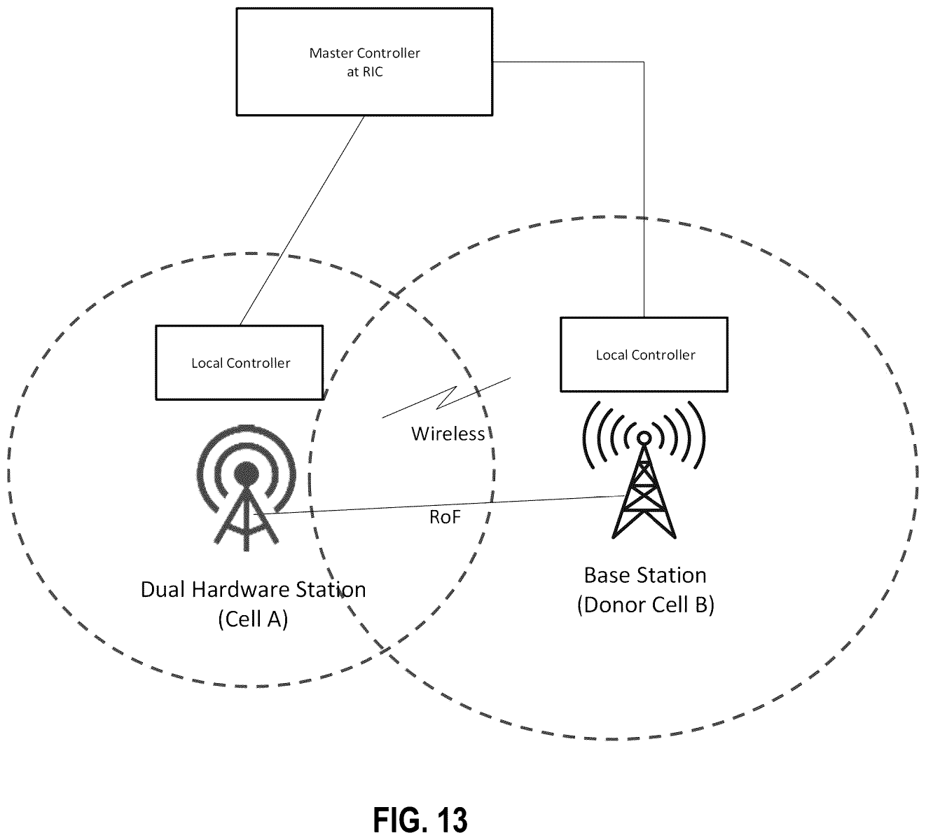

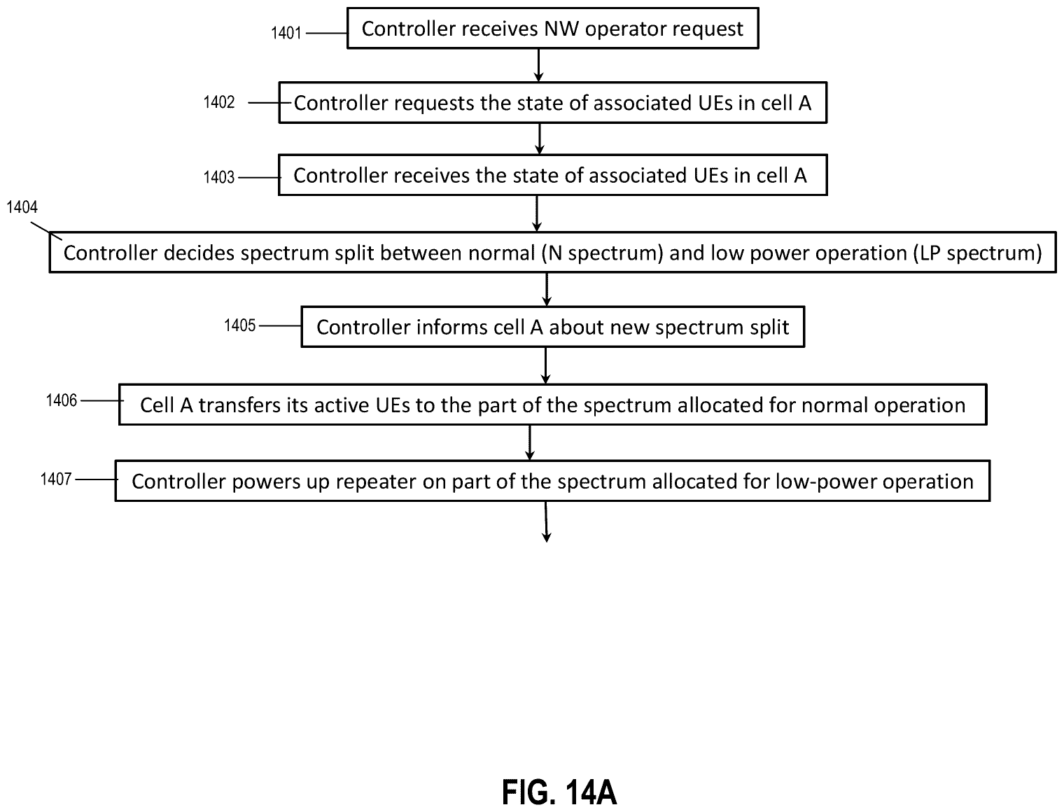

FIG. 13 illustrates some embodiments of gradual switching between normal and low power (repeater) operation. For this example, it is assumed that the network operator has chosen to transition cell A to low-power operation and offer coverage to cell A via the donor cell B. In response to this, the network operator sends a request to the controller of cell A.

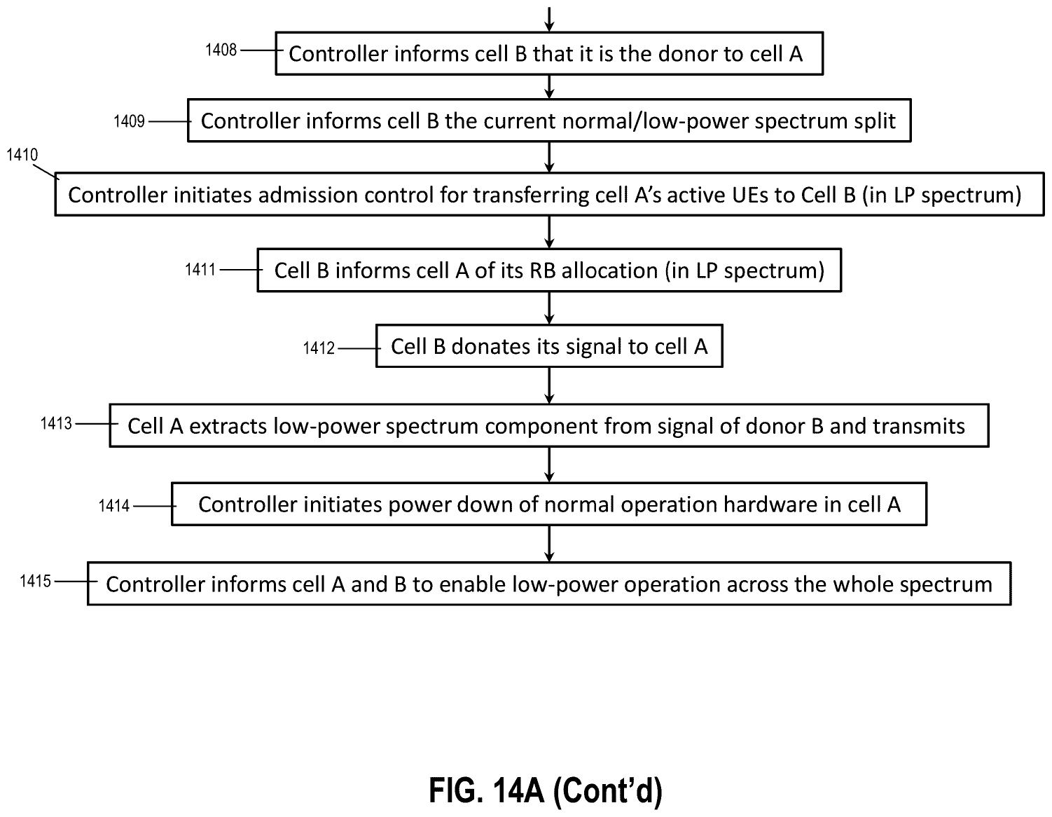

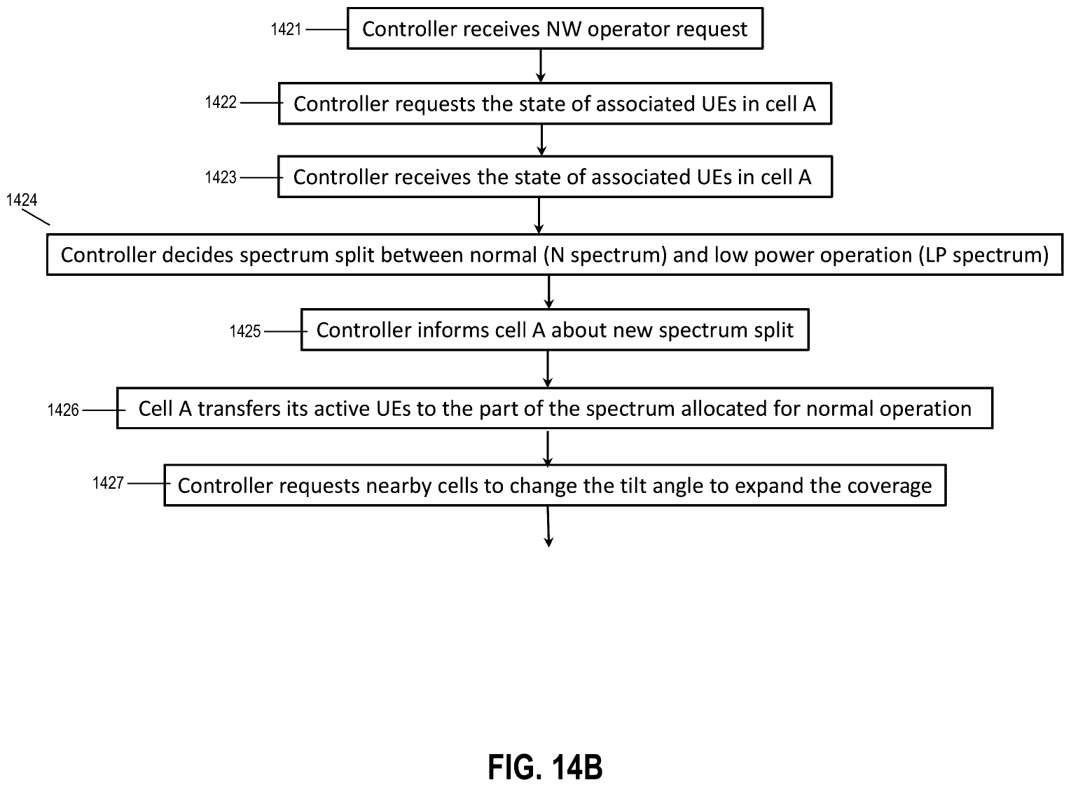

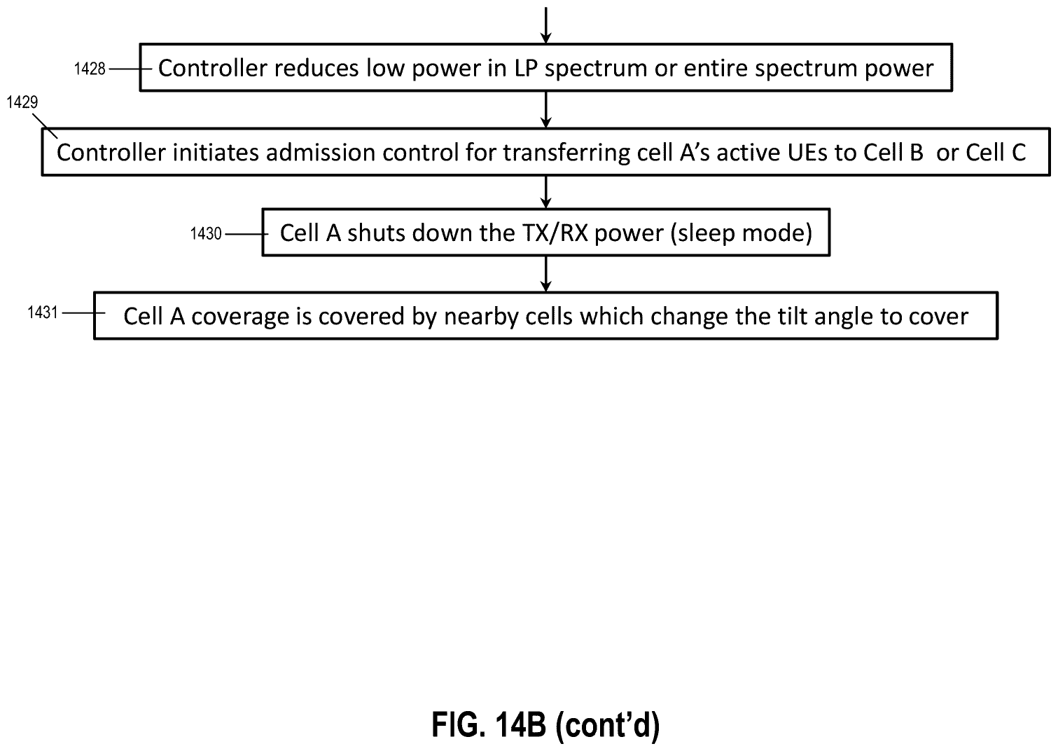

FIG. 14A illustrates some embodiments of a logical flow of the transition from normal operation in cell A. FIG. 14B illustrates some embodiments of a logical flow of the transition from power operation in cell A by use of a signal of donor cell B. Note that the operations performed by the controller in FIGS. 14A and 14B can be operations performed by the local controller, by the master controller or a combination of the local and master controllers. Note also that in both FIGS. 14A and 14B, the donor cell can be providing its signals wirelessly or via radio over fiber.

FIG. 14A is a data flow diagram of some embodiments a process for transition operation of a communication network into the low power consumption mode. Referring to FIG. 14A, the processor begins with processing logic in the controller of cell A receiving a network (NW) operator request (processing block 1401). In response to the network operator request, processing logic in a local controller requests the state of the associated user equipments (UEs) in cell A (processing block 1402). In response to these requests, processing logic in the controller receives the state of the associated UEs in cell A (processing block 1403) and decides to split the spectrum between the normal (N spectrum) and the low power operation (LP spectrum) (processing block 1404). Processing logic in a controller informs cell A about the new spectrum split (processing block 1405). Thereafter, cell A transfers its active UEs to the part of the spectrum allocated for normal operation (processing block 1406). Processing logic in the controller also powers up the repeater on part of the spectrum allocated for low power operation (processing block 1407) and informs cell B that it is the donor to cell A (processing block 1408). The controller also informs the neighboring cell B of the current/low power spectrum split (processing block 1409).

Processing logic in the controller initiates admission control for transferring the cell A's (active UEs to neighboring cell B (in the LP spectrum) (processing block 1410) and informs cell A of its resource block (RB) allocation in the LP spectrum (processing block 1411). Processing block in neighboring cell B donates its signal to cell A (processing block 1412). Cell A extracts a low power spectrum component from the signal of the donor neighboring cell B and transmits the component (processing block 1413). At this point, processing logic in the controller initiates power down of the normal operation hardware in cell A (processing block 1414) and informs both cell A and the neighboring cell B to enable low power operation across the whole spectrum (processing block 1415).

FIG. 14B is a flow diagram of some embodiments of process for transitioning from the normal mode to the sleep mode. Referring to FIG. 14B, the process begins by processing logic in the controller receiving a network operator request (processing block 1421). In response to the network operator request, processing logic in the controller requests the state of the associated UE in the first cell (cell A) (processing block 1422) and receives the state of the associated UE in the first cell (cell A) (processing block 1423). In response to this state of the associated UE in the cell, processing logic in the controller decides to determine the spectrum split between the normal (N spectrum) and the low power operation (LP spectrum) (processing block 1424) and informs the first cell (cell A) of the new spectrum split (processing block 1425). In response to the receiving information regarding the new spectrum split, the first cell (cell A) transfers it's active UEs to the part of the spectrum allocated for normal operation (processing block 1426) and requests the nearby cells to change their tilt angle to expand coverage (processing block 1427). Then, processing logic in the controller reduces low power in the low power spectrum or the entire spectrum power (processing block 1428). Processing logic also initiates ignition control for transferring the first cell (cell A) active UEs to a neighboring cell (e.g., cell B, or cell C, etc.) (processing block 1429). Afterwards, cell A shuts down the TX/RX power to enter the sleep mode (processing block 1430). When this occurs, cell A coverage is covered by nearby cells which changed their tilt angle to cover the first cells (cell A) coverage area (processing block 1431).

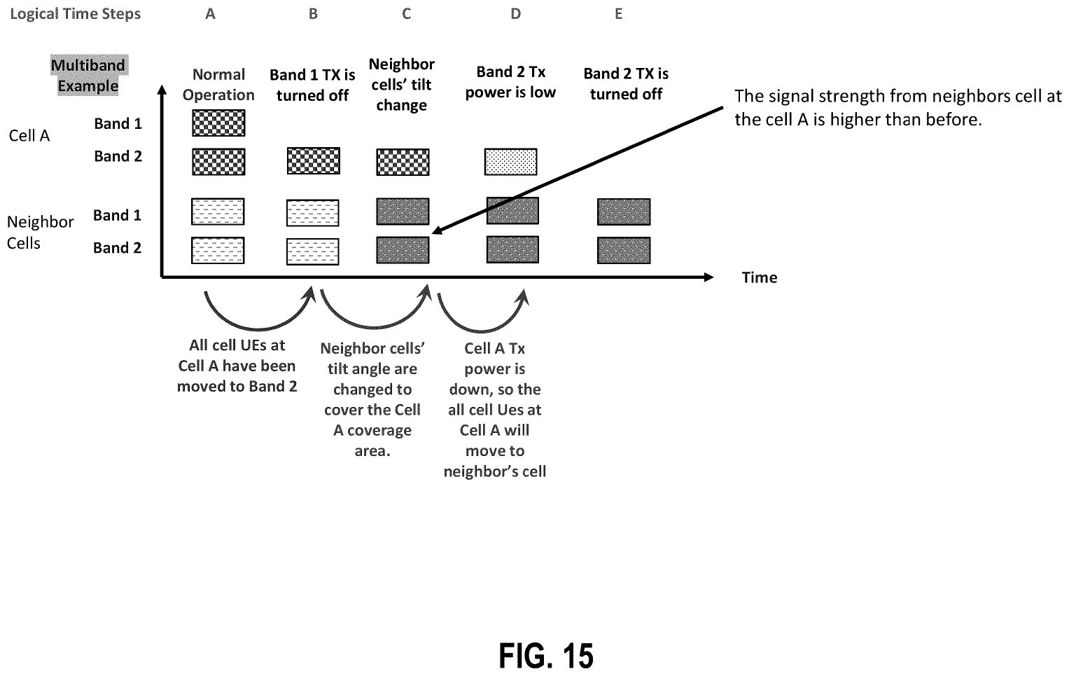

FIG. 15 illustrates as multi-band example of some embodiments of controller-based gradual switching from normal operation to sleep operation. Referring to FIG. 15, during normal operation at time A, UEs are on bands 1 and 2, while neighboring cells use bands 1 and 2. When cell A is to move to a reduced power consumption state, at time B, all the UEs at cell A are moved to one of the bands, e.g. band 2, and then the local controller of cell A turns off band 1 TX. At time C, one or more of neighbor cells' tilt angles are changed to cover the cell A coverage area. In some embodiments, the signal strength from the neighbor cells at cell A is made higher than before the tilt angle change. At time D, band 2 TX in powered low in cell A, thereby causing all the UEs of cell A to move to one of the neighboring cells. After this occurs, the local controller of cell A turns off band 2 TX.

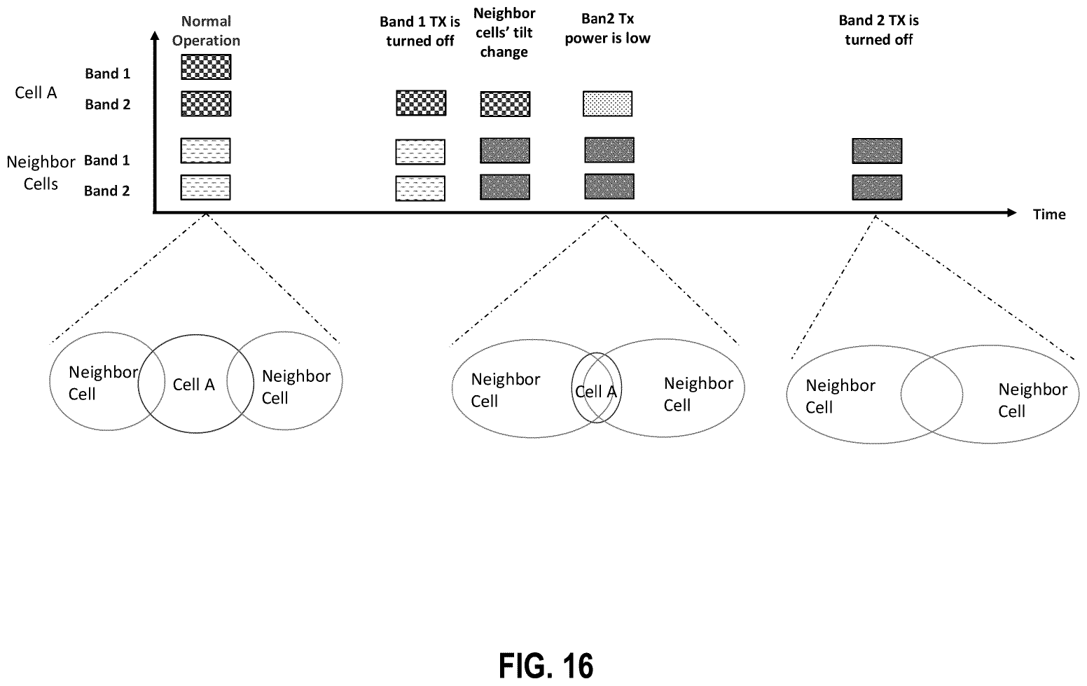

FIG. 16 illustrates another multi-band example of some other embodiments of controller-based gradual switching from normal operation to sleep operation. Referring to FIG. 16, the coverage areas of cell A and the neighboring cells are shown at different times. At first, cell A's coverage area is between and slightly overlapping the neighboring cells. After band 1 TX is turned off in cell A, band 2 TX is made low power cell A and the neighboring cells have undergone a tilt change, the coverage area of cell A is reduced while the coverage area of the two neighboring cells expands to cover cell A's original coverage area. Then band 2 TX is turned off in cell A, causing cell A's coverage area to disappear and the two neighboring cells to use their expanded coverage area to cover cell A's coverage area.

There is a number of example embodiments described herein.

Example 1 is a communication network including: a plurality of cells, where each cell of the plurality of cells having a base station and a local network controller and at least one of the cells having both hardware for performing cellular communication operations and repeater hardware to enable the at least one cell to operate as a repeater during a first reduced power consumption state. The communication network also includes a master network controller coupled to the local network controllers in each of the plurality of cells, wherein the master network controller is configured to select the at least one cell to enter the first reduced power consumption state and signal the local network controller of the at least one cell to enable the repeater hardware to have the at least one cell operate as a repeater.

Example 2 is the communication network of example 1 that may optionally include that the local controller of the at least one cell hands off UEs to one or more cells nearby the at least one cell in response to the signaling from the master controller that the at least one cell is entering the first reduced power consumption state.

Example 3 is the communication network of example 1 that may optionally include that the master controller signals one or more cells of the plurality of cells to operate as donor cells for the at least one cell while the at least one cell transitions into and/or is in the reduced power consumption state.

Example 4 is the communication network of example 3 that may optionally include that base stations of the donor cells change a tilt angle of their antenna to expand their coverage area so that its signal reaches a donor antenna.

Example 5 is the communication network of example 3 that may optionally include that at least one of the plurality of donor cells is communicably coupled to the donor cell via a wired connection.

Example 6 is the communication network of example 3 that may optionally include that at least one of the plurality of donors donates one or more frequency bands for use with communications with the at least one cell.

Example 7 is the communication network of example 3 that may optionally include that one donor cell of the plurality of donor cells is a donor cell for a first plurality of cells with both hardware for performing cellular communication operations and repeater hardware.

Example 8 is the communication network of example 1 that may optionally include that only the local controller of the at least one cell controls the cell/repeater operation on cell.

Example 9 is the communication network of example 8 that may optionally include that the local controller is operable to switch partially when transitioning to the reduced power consumption state.

Example 10 is the communication network of example 9 that may optionally include that one or more, but not all, of the bands of the cell is transmitting when transitioning to the reduced power consumption state and the remaining bands not transitioned to low-power operation are continued to be used for transmit or are put to sleep.

Example 11 is the communication network of example 1 that may optionally include that the master controller provides a trigger to the local controller of the at least one cell for initiating switching from normal to the reduced power consumption state power and/or vice versa.

Example 12 is the communication network of example 11 that may optionally include that while in the reduced power consumption state, the at least one cell is communicably coupled to one or more donor cells and receives radio-over-fiber signals from at least one donor cell.

Example 13 is the communication network of example 11 that may optionally include that the reduced power consumption state comprises switching the at least one cell to sleep and changing the tilt each of its donor cells to extend their coverage.

Example 14 is the communication network of example 1 that may optionally include that the master controller provides a trigger to the local controller of the at least one cell to initiate a sleep mode or select the repeater function.

Example 15 is the communication network of example 14 that may optionally include that the master controller is operable to detect a potential coverage hole if the based station of the at least one cells goes into the sleep mode and, in response thereto, signals either the base state to operate as a repeater or signals one or more neighboring cells to perform a tilt change with respect to their antenna to expand coverage over the coverage area of the at least one cell.

Example 16 is a cell including: a local controller; and hardware for performing cellular communication operations and repeater hardware to enable the at least one cell to operate as a repeater during a first reduced power consumption state.

Example 17 is the cell of example 16 that may optionally include that the local controller hands off UEs to one or more nearby cells in response to received control signaling indicating the cell is to enter a reduced power consumption state.

Example 18 is the cell of example 17 that may optionally include that the local controller is operable to control the hardware to operable using cellular communication or operate as a repeater in the reduced power consumption state.

Example 19 is the cell of example 18 that may optionally include that the local controller is operable to switch from using multiple bands to using one band when transitioning to the reduced power consumption state.

Example 20 is the cell of example 19 that may optionally include that the local controller controls the hardware to transmit using one or more, but not all, of the multiple bands when the cell is transitioning to the reduced power consumption state and the remaining bands not transitioned to low-power operation are continued to be used for transmit or are put to sleep.

Example 21 is a method that includes transmitting, by each cell of a plurality of cells in a communication network, using hardware for performing cellular communication operations; selecting, by a master network controller coupled to the local network controllers in each of the plurality of cells, at least one cell to enter a reduced power consumption state; signaling, by the master network controller, the local network controller of the at least one cell to enable repeater hardware to have the at least one cell operate as a repeater; and at least one cell operating as a repeater using repeater hardware during the reduced power consumption state.

Example 22 is the method of example 21 that may optionally include handing off, by the local controller of the at least one cell, UEs to one or more cells nearby the at least one cell in response to the signaling from the master controller that the at least one cell is to enter the reduced power consumption state.

Example 23 is the cell of example 21 that may optionally include changing the tilt angle of one or more antenna of the donor cells to expand their coverage area to cover at least a portion of the coverage area of the at least one cell while the at least one cell transitions into and/or is in the reduced power consumption state.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Whereas many alterations and modifications of the present disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the disclosure.

1. A communication network comprising:
a plurality of cells, each cell of the plurality of cells having a base station and a local network controller, and at least one of the cells having both hardware for performing cellular communication operations and repeater hardware to enable the at least one cell to operate as a repeater during a first reduced power consumption state; and
a master network controller coupled to the local network controllers in each of the plurality of cells, wherein the master network controller is configured to select the at least one cell to enter the first reduced power consumption state and signal the local network controller of the at least one cell to enable the repeater hardware to have the at least one cell operate as a repeater.

2. The communication network of claim 1 wherein the local controller of the at least one cell hands off UEs to one or more cells nearby the at least one cell in response to the signaling from the master controller that the at least one cell is entering the first reduced power consumption state.

3. The communication network of claim 1 wherein the master controller signals one or more cells of the plurality of cells to operate as donor cells for the at least one cell while the at least one cell transitions into and/or is in the reduced power consumption state.

4. The communication network of claim 3 wherein base stations of the donor cells change a tilt angle of their antenna to expand their coverage area so that its signal reaches a donor antenna.

5. The communication network of claim 3 wherein at least one of the plurality of donor cells is communicably coupled to the donor cell via a wired connection.

6. The communication network of claim 3 wherein at least one of the plurality of donors donates one or more frequency bands for use with communications with the at least one cell.

7. The communication network of claim 3 wherein one donor cell of the plurality of donor cells is a donor cell for a first plurality of cells with both hardware for performing cellular communication operations and repeater hardware.

8. The communication network of claim 1 wherein only the local controller of the at least one cell controls the cell/repeater operation on cell.

9. The communication network of claim 8 wherein the local controller is operable to switch partially when transitioning to the reduced power consumption state.

10. The communication network of claim 9 wherein one or more, but not all, of the bands of the cell is transmitting when transitioning to the reduced power consumption state and the remaining bands not transitioned to low-power operation are continued to be used for transmit or are put to sleep.

11. The communication network of claim 1 wherein the master controller provides a trigger to the local controller of the at least one cell for initiating switching from normal to the reduced power consumption state power and/or vice versa.

12. The communication network of claim 11 wherein while in the reduced power consumption state, the at least one cell is communicably coupled to one or more donor cells and receives radio-over-fiber signals from at least one donor cell.

13. The communication network of claim 11 wherein the reduced power consumption state comprises switching the at least one cell to sleep and changing the tilt each of its donor cells to extend their coverage.

14. The communication network of claim 1 wherein the master controller provides a trigger to the local controller of the at least one cell to initiate a sleep mode or select the repeater function.

15. The communication network of claim 14 wherein the master controller is operable to detect a potential coverage hole if the based station of the at least one cells goes into the sleep mode and, in response thereto, signals either the base state to operate as a repeater or signals one or more neighboring cells to perform a tilt change with respect to their antenna to expand coverage over the coverage area of the at least one cell.

16. A cell comprising:
a local controller; and
hardware for performing cellular communication operations and repeater hardware to enable the at least one cell to operate as a repeater during a first reduced power consumption state.

17. The cell of claim 16 wherein the local controller hands off UEs to one or more nearby cells in response to received control signaling indicating the cell is to enter a reduced power consumption state.

18. The cell of claim 17 wherein the local controller is operable to control the hardware to operable using cellular communication or operate as a repeater in the reduced power consumption state.

19. The cell of claim 18 wherein the local controller is operable to switch from using multiple bands to using one band when transitioning to the reduced power consumption state.

20. The cell of claim 19 wherein the local controller controls the hardware to transmit using one or more, but not all, of the multiple bands when the cell is transitioning to the reduced power consumption state and the remaining bands not transitioned to low-power operation are continued to be used for transmit or are put to sleep.

21. A method comprising:
transmitting, by each cell of a plurality of cells in a communication network, using hardware for performing cellular communication operations;
selecting, by a master network controller coupled to the local network controllers in each of the plurality of cells, at least one cell to enter a reduced power consumption state;
signaling, by the master network controller, the local network controller of the at least one cell to enable repeater hardware to have the at least one cell operate as a repeater; and
at least one cell operating as a repeater using repeater hardware during the reduced power consumption state.

22. The method of claim 21 further comprising handing off, by the local controller of the at least one cell, UEs to one or more cells nearby the at least one cell in response to the signaling from the master controller that the at least one cell is to enter the reduced power consumption state.

23. The method of claim 21 further comprising changing the tilt angle of one or more antenna of the donor cells to expand their coverage area to cover at least a portion of the coverage area of the at least one cell while the at least one cell transitions into and/or is in the reduced power consumption state.
